(19) United States
(12) Patent Application Publication
(10) Pub. No.: US 2022/0149510 A1
(43) Pub. Date: May 12, 2022

(54) ANTENNA DEVICE

(71) Applicant: SONY SEMICONDUCTOR SOLUTIONS CORPORATION, KANAGAWA (JP)

(72) Inventors: TAKAAKI HASHIGUCHI, KANAGAWA (JP); OSAMU KOZAKAI, ATSUGI-SHI (JP)

(21) Appl. No.: 17/435,873

(22) PCT Filed: Jan. 6, 2020
(86) PCT No.: PCT/JP2020/000026

§ 371 Date: Sep. 2, 2021

(30) Foreign Application Priority Data
Mar. 14, 2019 (JP) 2019-046634

(51) Int. Cl. H01Q 1/27; H01Q 1/48

(52) U.S. Cl. CPC H01Q 1/273; H01Q 1/48

(57) ABSTRACT

An object is to, in a wireless communication device used in the vicinity of a human body and including a substrate and an antenna, increase a size of the antenna as large as possible and reduce an influence on the human body. An antenna device includes a ground substrate, a vertical antenna element, and a horizontal antenna element. The ground substrate is connected to a radio frequency signal source. The vertical antenna element has one end connected to a feed point to which a signal is supplied from the radio frequency signal source, and extends in a direction vertical to a substrate surface of the ground substrate. The horizontal antenna element is connected to another end of the vertical antenna element and extends in a horizontal direction parallel to the substrate surface.

### TECHNICAL FIELD

The present technology relates to an antenna device. Specifically, the present technology relates to an antenna device used while being close to a human body.

### BACKGROUND ART

In order to perform wireless communication, antennas of various shapes have been conventionally used in wireless devices and the like. In a small device in particular, a loop antenna, a monopole antenna, a dipole antenna, or the like is used because those antennas have a simple structure. For example, there is proposed a wireless device in which a substrate functioning as a reflector while being located close to a human body and a loop antenna having a loop surface vertical to the substrate are arranged (see, for example, Patent Document 1).

### CITATION LIST

### Patent Document

Patent Document 1: Japanese Patent Application Laid-Open No. 11-136020

### SUMMARY OF THE INVENTION

### Problems to be Solved by the Invention

In the related art cited above, radio waves directed toward a human body are blocked by the reflector, thereby improving a gain of the loop antenna, as compared with a case where the reflector is not used. However, in this wireless device, the reflector and the loop antenna need to be separately arranged to have a certain distance therebetween. Thus, it is necessary to reduce a size of the antenna due to restriction of a size of the device. Therefore, the wireless device can reduce a decrease in characteristics caused by absorption of radio waves into the human body, but instead has a problem that performance of the antenna decreases due to reduction in size of the antenna.

The present technology has been made in view of such a situation, and an object thereof is to, in a wireless communication device used in the vicinity of a human body and including a substrate and an antenna, increase a size of the antenna as large as possible and reduce an influence on the human body.

### Solutions to Problems

The present technology has been made to solve the above-described problem, and a first aspect thereof is an antenna device including: a ground substrate connected to a ground terminal of a radio frequency signal source; a vertical antenna element having one end connected to a feed point of the radio frequency signal source and extending in a direction vertical to a substrate surface of the ground substrate; and a horizontal antenna element connected to another end of the vertical antenna element and extending in a horizontal direction parallel to the substrate surface. Therefore, it is possible to increase a substantial size of the antenna.

Further, in the first aspect, a housing including a conductive member having a surface parallel to the ground substrate may be further included, and the ground substrate may be connected to the conductive member. Therefore, a current can flow through the ground substrate and the conductive member arranged in the vicinity of the human body.

Further, in the first aspect, a reactance element connected to the one end of the vertical antenna element may be further included. Therefore, it is possible to perform impedance matching and adjustment of a resonant frequency.

Further, in the first aspect, a control unit that controls a reactance value of the reactance element may be further included. Therefore, it is possible to dynamically perform the impedance matching and the adjustment of the resonant frequency.

Further, in the first aspect, a reactance element connected in series to the one end of the vertical antenna element may be further included. Therefore, it is possible to perform the impedance matching and the adjustment of the resonant frequency.

Further, in the first aspect, a control unit that controls a reactance inductance value of the reactance element may be further included. Therefore, it is possible to dynamically perform the impedance matching and the adjustment of the resonant frequency.

Further, in the first aspect, the vertical antenna element may include first and second vertical antenna elements, one end of the horizontal antenna element may be connected to the another end of the first vertical antenna element, and another end of the horizontal antenna element may be connected to one end of the second vertical antenna element.

Further, in the first aspect, the vertical antenna element may be connected to a predetermined position of the ground substrate in a predetermined direction vertical to the vertical direction and the horizontal direction; and, in the predetermined direction, a thickness of the ground substrate within a predetermined range including the predetermined position may be larger than a thickness of the ground substrate within a range other than the predetermined range.

Further, in the first aspect, the vertical antenna element may include first and second vertical antenna elements; the horizontal antenna element may include first and second horizontal antenna elements having different lengths; one end of the first vertical antenna element may be connected to one end of the first horizontal antenna element; and one end of the second vertical antenna element may be connected to one end of the second horizontal antenna element. Therefore, radio waves of a plurality of frequencies can be transmitted and received.

### BRIEF DESCRIPTION OF DRAWINGS

FIG. 1 illustrates an example of an external view of an antenna device according to a first embodiment of the present technology.

FIG. 2 is a block diagram showing a configuration example of the antenna device according to the first embodiment of the present technology.

FIG. 3 illustrates an example of a perspective view of an antenna according to the first embodiment of the present technology.

FIG. 4 illustrates an example of a cross-sectional view of the antenna device according to the first embodiment of the present technology.

FIG. 5 is a circuit diagram showing a configuration example of the antenna device according to the first embodiment of the present technology.

FIG. 6 is an explanatory view of an image effect according to the first embodiment of the present technology.

FIG. 7 is a graph showing an example of antenna characteristics according to the first embodiment of the present technology.

FIG. 8 illustrates an example of a perspective view of an antenna according to a modification example of the first embodiment of the present technology.

FIG. 9 is a block diagram showing a configuration example of an antenna device according to a second embodiment of the present technology.

FIG. 10 illustrates an example of a perspective view of an antenna according to the second embodiment of the present technology.

FIG. 11 is a circuit diagram showing a configuration example of the antenna device according to the second embodiment of the present technology.

FIG. 12 is a block diagram showing a configuration example of an antenna device according to a third embodiment of the present technology.

FIG. 13 is a block diagram showing a configuration example of an antenna device according to a modification example of the third embodiment of the present technology.

FIG. 14 is a circuit diagram showing a configuration example of a variable capacitor circuit according to a modification example of the third embodiment of the present technology.

FIG. 15 is a block diagram showing a configuration example of an antenna device according to a fourth embodiment of the present technology.

FIG. 16 is a block diagram showing a configuration example of an antenna device according to a modification example of the fourth embodiment of the present technology.

FIG. 17 is a circuit diagram showing a configuration example of a variable inductor circuit according to a modification example of the fourth embodiment of the present technology.

FIG. 18 is a block diagram showing a configuration example of an antenna device according to a fifth embodiment of the present technology.

FIG. 19 illustrates an example of a cross-sectional view of the antenna device according to the fifth embodiment of the present technology.

FIG. 20 is a block diagram showing a configuration example of an antenna device according to a sixth embodiment of the present technology.

FIG. 21 is a block diagram showing a configuration example of an antenna device according to a seventh embodiment of the present technology.

FIG. 22 illustrates an example of a perspective view of an antenna according to a modification example of an eighth embodiment of the present technology.

### MODE FOR CARRYING OUT THE INVENTION

Hereinafter, modes for carrying out the present technology (hereinafter, referred to as “embodiments”) will be described. Description will be made in the following order.

1. First embodiment (an example where an element is arranged in a direction vertical to a ground substrate)

2. Second embodiment (an example where an element is arranged in a direction vertical to a ground substrate and is connected to a reactance)

3. Third embodiment (an example where an element is arranged in a direction vertical to a ground substrate and is connected to a variable reactance)

4. Fourth embodiment (an example where an element is arranged in a direction vertical to a ground substrate and is connected to a variable reactance)

5. Fifth embodiment (an example where two elements are arranged in a direction vertical to a ground substrate)

6. Sixth embodiment (an example where two elements are arranged in a direction vertical to a ground substrate and are connected to a variable reactance)

7. Seventh embodiment (an example where two elements are arranged in a direction vertical to a ground substrate and are connected to a variable reactance)

8. Eighth embodiment (an example where an element is arranged in a vertical direction in a ground substrate having an ununiform thickness)

### 1. First Embodiment

[Configuration Example of Antenna Device]

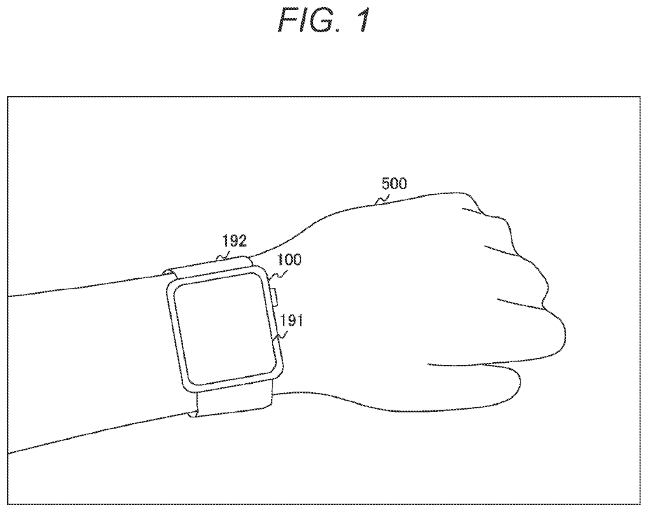

FIG. 1 illustrates an example of an external view of an antenna device 100 according to a first embodiment of the present technology. The antenna device 100 is a device that performs wireless communication by using an antenna. For example, a wearable device such as a smart watch is used as the antenna device 100.

For example, a strip-shaped wristwatch band 192 is attached to the antenna device 100. A user can wear the antenna device 100 like a wristwatch by winding the wristwatch band 192 around a wrist of a human body 500. Further, various pieces of information such as time and the number of steps are displayed on a predetermined display surface 191 of a housing of the antenna device 100. In a case where a surface of the housing facing the display surface 191 is defined as a back surface, the back surface is in contact with the human body 500 while the antenna device 100 is worn.

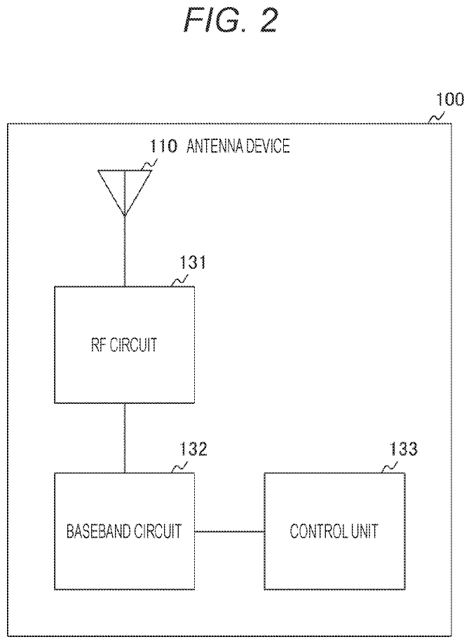

FIG. 2 is a block diagram showing a configuration example of the antenna device 100 according to the first embodiment of the present technology. The antenna device 100 includes an antenna 110, an RF circuit 131, a baseband circuit 132, and a control unit 133.

The antenna 110 mutually converts a radio wave and a radio frequency (RF) signal. The antenna 110 supplies an RF signal converted from a radio wave to the RF circuit 131. Further, in a case where an RF signal is supplied from the RF circuit 131, the antenna 110 converts the RF signal into a radio wave and outputs the radio wave.

The RF circuit 131 mutually converts a baseband signal and an RF signal. The RF circuit 131 converts a baseband signal supplied from the baseband circuit 132 into an RF signal by modulation and supplies the RF signal to the antenna 110. Further, the RF circuit 131 converts an RF signal supplied from the antenna 110 into a baseband signal by demodulation, and supplies the baseband signal to the baseband circuit 132.

The baseband circuit 132 generates or processes a baseband signal. The baseband circuit 132 generates a baseband signal from data to be transmitted and supplies the baseband signal to the RF circuit 131. Further, the baseband circuit 132 processes a baseband signal supplied from the RF circuit 131 and acquires received data.

The control unit 133 controls operation of the baseband circuit 132.

[Configuration Example of Antenna]

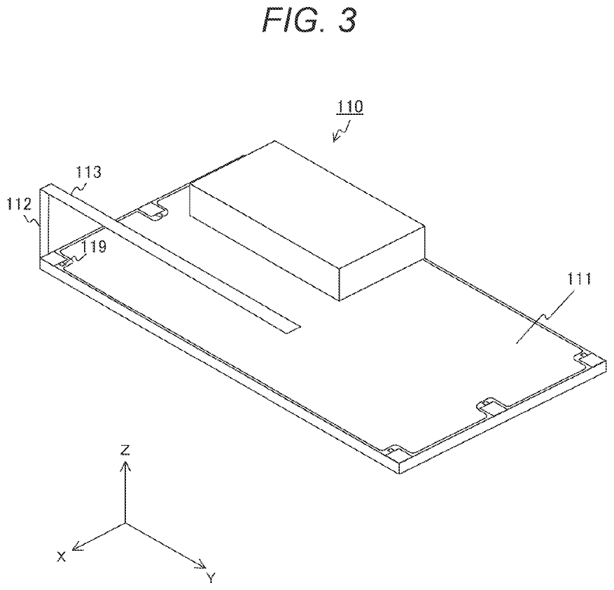

FIG. 3 is a perspective view showing a configuration example of the antenna 110 according to the first embodiment of the present technology. The antenna 110 includes a ground substrate 111, a vertical antenna element 112, and a horizontal antenna element 113.

The ground substrate 111 is a plate-like substrate functioning as a ground element of the antenna 110. Various circuits such as the RF circuit 131 and the baseband circuit 132 are mounted on the ground substrate 111. Further, the ground substrate 111 has a uniform thickness.

Hereinafter, a predetermined direction parallel to a substrate surface of the ground substrate 111 is defined as an X direction, and a direction vertical to the substrate surface is defined as a Z direction. Further, a direction vertical to the X direction and the Z direction is defined as a Y direction.

The vertical antenna element 112 is an antenna element extending in the direction vertical to the substrate surface (i.e., in the Z direction). A feed point 119 is connected to one end of the vertical antenna element 112, and an RF signal is supplied from a circuit (such as the RF circuit 131) on the ground substrate 111 via the feed point.

The horizontal antenna element 113 is an element extending in the Y direction parallel to the substrate surface. The horizontal antenna element 113 is connected to another end of the vertical antenna element 112.

The antenna 110 having the above configuration is generally called a monopole antenna.

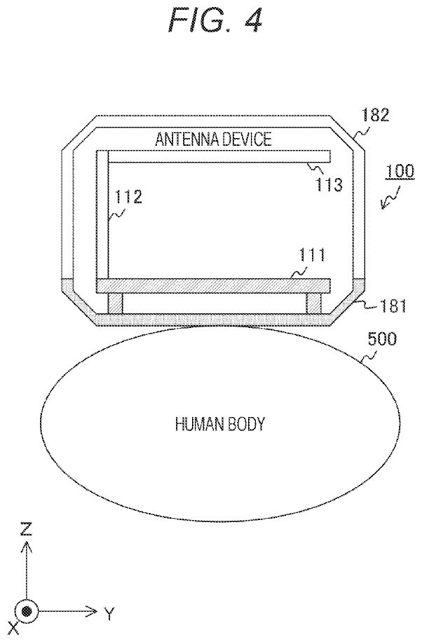

FIG. 4 illustrates an example of a cross-sectional view of the antenna device 100 according to the first embodiment of the present technology. The antenna 110 including the ground substrate 111, the vertical antenna element 112, and the horizontal antenna element 113 is stored in a housing including a metal-plated member 181 and a plastic member 182.

The metal-plated member 181 forms a back surface in contact with the human body 500, and the back surface is parallel to the ground substrate 111. The metal-plated member 181 is electrically connected to the ground substrate 111.

Further, the antenna 110 has a U shape rotated 90 degrees clockwise as seen from the X direction.

Note that a part of the housing is the metal-plated member 181, but the entire housing may be a metal-plated member. Further, the metal-plated member 181 is an example of a conductive member recited in the claims.

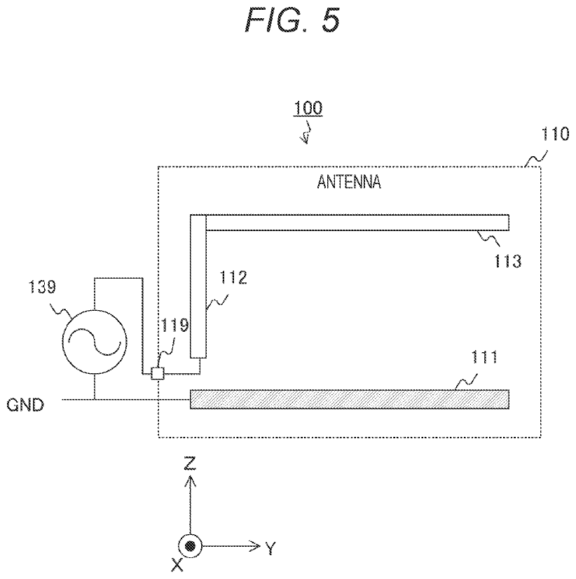

FIG. 5 is a circuit diagram showing a configuration example of the antenna device 100 according to the first embodiment of the present technology. The antenna device 100 includes the antenna 110 and a radio frequency signal source 139. Further, the antenna 110 includes the ground substrate 111, the vertical antenna element 112, and the horizontal antenna element 113.

The radio frequency signal source 139 supplies an RF signal to the feed point 119. The radio frequency signal source 139 includes, for example, the RF circuit 131 and the like.

The ground substrate 111 is connected to a ground terminal of the radio frequency signal source 139. The vertical antenna element 112 has the one end connected to the feed point 119 and extends in the direction vertical to the substrate surface of the ground substrate (i.e., in the Z direction). Further, the horizontal antenna element 113 is connected to the another end of the vertical antenna element 112 and extends in the horizontal direction parallel to the substrate surface of the ground substrate 111 (e.g., in the Y direction).

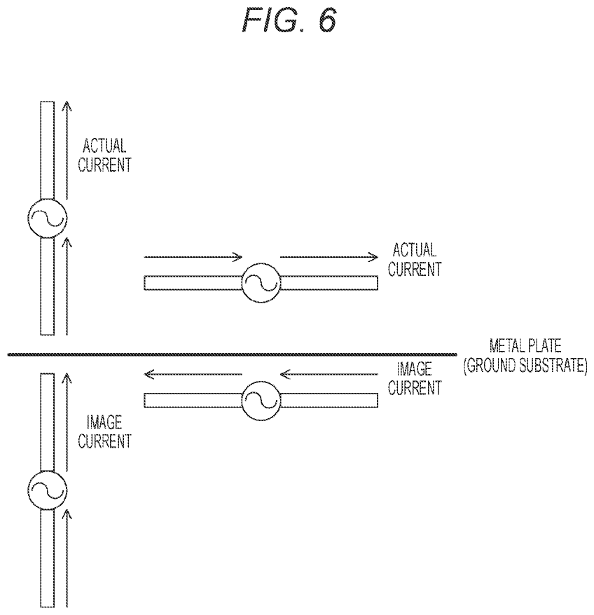

FIG. 6 is an explanatory view of an image effect according to the first embodiment of the present technology. As illustrated in FIG. 4, the ground substrate 111 of the antenna 110 is connected to the metal-plated member 181 in contact with or close to the human body 500. Further, as illustrated in FIG. 5, the radio frequency signal source 139 is connected to the vertical antenna element 112 and the ground substrate 111. Therefore, currents flowing through the horizontal antenna element 113 and the ground substrate 111 in horizontally opposite directions offset each other. Thus, radiation by a current flowing through the vertical antenna element is dominant. The current flowing through the vertical antenna element induces an image current in the same direction in the human body.

As a well-known case, for example, a ¼ wavelength monopole antenna functions as a ½ wavelength dipole antenna because of the image current. Such an effect to generate an image on the ground is called an image effect.

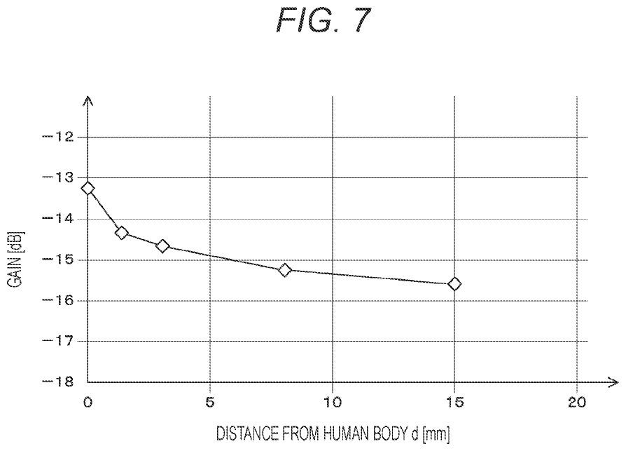

FIG. 7 is a graph showing an example of a relationship between a distance from the ground substrate 111 to the human body and a gain. In FIG. 7, a vertical axis represents a gain of the antenna 110, and a horizontal axis represents the distance from the ground substrate 111 to the human body in the Z direction.

As shown in FIG. 7, as the distance from the human body is shorter, a current flowing through the human body increases, and the gain is improved by the image effect.

As described above, in the first embodiment of the present technology, the radio frequency signal source 139 is connected between the ground substrate 111 provided close to the human body and the vertical antenna element 112. Thus, the image effect of a current is generated in the vertical direction, and radiation characteristics can be improved in the vicinity of the human body. In addition, it is unnecessary to separate (independently provide) the ground substrate and the antenna, and therefore the antenna can be increased in size as large as possible.

### Modification Example

In the first embodiment described above, one vertical antenna element 112 and one horizontal antenna element 113 are arranged. However, this configuration cannot transmit or receive radio waves of a plurality of frequencies. The antenna device 100 according to a modification example of the first embodiment is different from that of the first embodiment in that a plurality of vertical antenna elements and a plurality of horizontal antenna elements having different lengths are arranged.

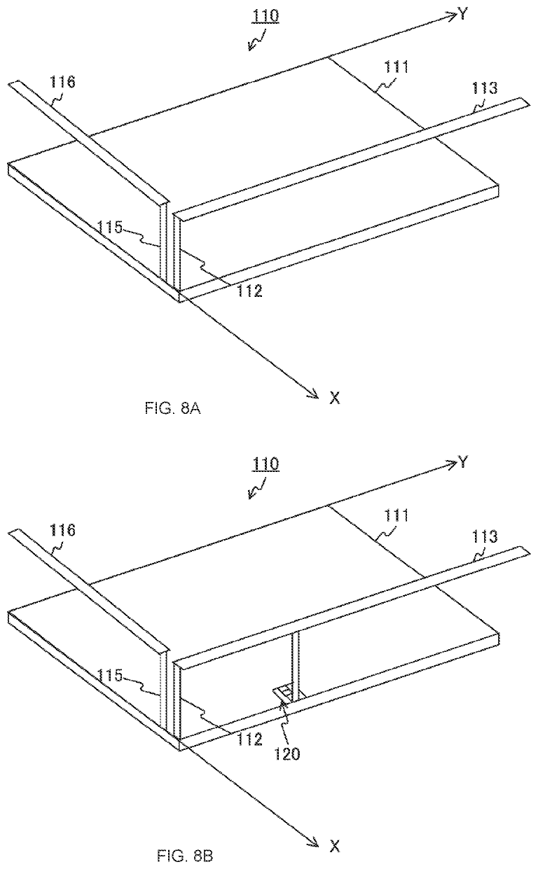

a of FIG. 8 illustrates an example of a perspective view of the antenna 110 according to the modification example of the first embodiment of the present technology. The antenna 110 according to the modification example of the first embodiment is different from that of the first embodiment in that a vertical antenna element 115 and a horizontal antenna element 116 are further provided.

The vertical antenna element 115, as well as the vertical antenna element 112, extends in the direction vertical to the ground substrate 111 and is connected to the radio frequency signal source 139 (not illustrated). Further, the horizontal antenna element 116 is parallel to the ground substrate 111, extends in a direction different from the direction in which the horizontal antenna element 113 extends, and has one end connected to the vertical antenna element 115. Further, the horizontal antenna element 116 is different in length from the horizontal antenna element 113.

The sum of the lengths of a pair of the vertical antenna element 115 and the horizontal antenna element 116 is different from that of a pair of the vertical antenna elements 112 and the horizontal antenna elements 113. Therefore, impedances of those pairs are different, and resonant frequencies thereof are different from each other. Accordingly, the antenna 110 can transmit and receive two radio waves having different frequencies.

Note that although two pairs of the vertical and horizontal antenna elements are arranged, three or more pairs of the vertical and horizontal antenna elements can be arranged to transmit and receive three or more frequencies. Further, as illustrated in b of the FIG. 8, a reactance such as a reactance element 120 can also be further connected.

As described above, in the modification example of the first embodiment of the present technology, the vertical antenna element 115 and the horizontal antenna element 116 having a different length from the vertical antenna element 112 and the horizontal antenna element 113 are further provided. Therefore, two radio waves having different frequencies can be transmitted and received.

### 2. Second Embodiment

In the first embodiment described above, only the antenna 110 is connected to the radio frequency signal source 139. In this configuration, however, impedance matching and adjustment of a resonant frequency in the antenna 110 may be difficult due to shortage of a capacitive component and the like. The antenna device 100 according to a second embodiment is different from that of the first embodiment in that a reactance element is added. Herein, the reactance may be either a capacitive reactance or an inductive reactance.

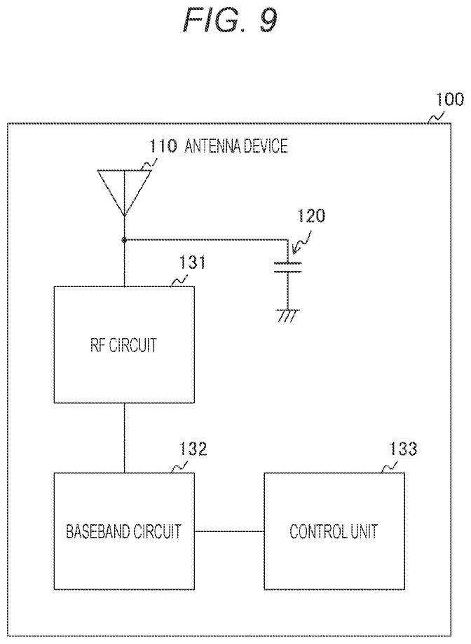

FIG. 9 is a block diagram showing a configuration example of the antenna device 100 according to the second embodiment of the present technology. The antenna device 100 according to the second embodiment is different from that of the first embodiment in that the reactance element 120 is further provided. The reactance element 120 is connected in parallel to the antenna 110. As illustrated in FIG. 9, for example, a capacitive element is used as the reactance element 120.

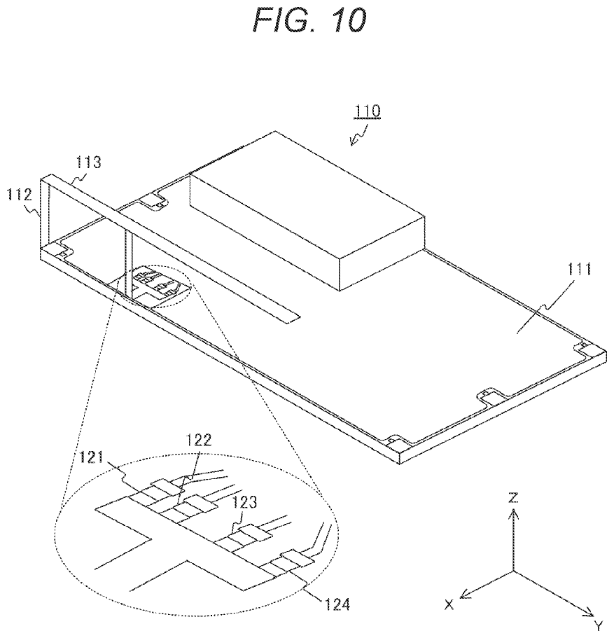

FIG. 10 illustrates an example of a perspective view of the antenna 110 according to the second embodiment of the present technology. Reactance elements 121 to 124 are connected in parallel to the horizontal antenna element 113. For example, a capacitive element is used as the reactance elements 121 to 124. A combined capacitance of those capacitive elements corresponds to the reactance element 120.

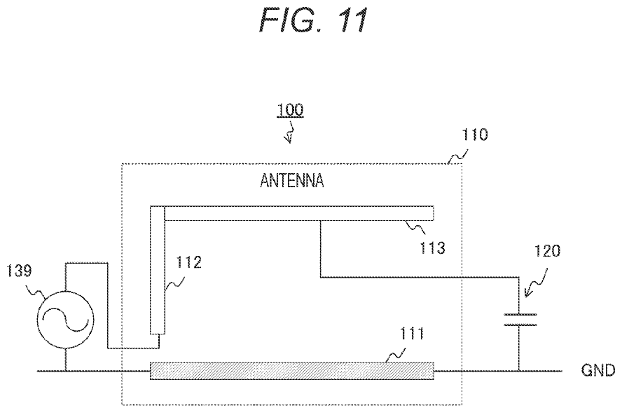

FIG. 11 is a circuit diagram showing a configuration example of the antenna device 100 according to the second embodiment of the present technology. The reactance element 120 is inserted between the horizontal antenna element 113 and the ground substrate 111. By changing a reactance value of the reactance element 120, the impedance matching and the adjustment of the resonant frequency can be performed. However, the reactance value of the reactance element 120 is statically changed, and the reactance value is fixed during operation of the antenna device 100.

As described above, according to the second embodiment of the present technology, the reactance element 120 is connected to the antenna 110, and thus the impedance matching and the adjustment of the resonant frequency can be performed by changing the reactance value.

### 3. Third Embodiment

In the second embodiment described above, the reactance element 120 having a fixed value is arranged. In this configuration, however, the resonant frequency cannot be changed during the operation of the antenna device 100. The antenna device 100 according to a third embodiment is different from that of the second embodiment in that a variable reactance element is provided and a reactance value thereof is dynamically controlled.

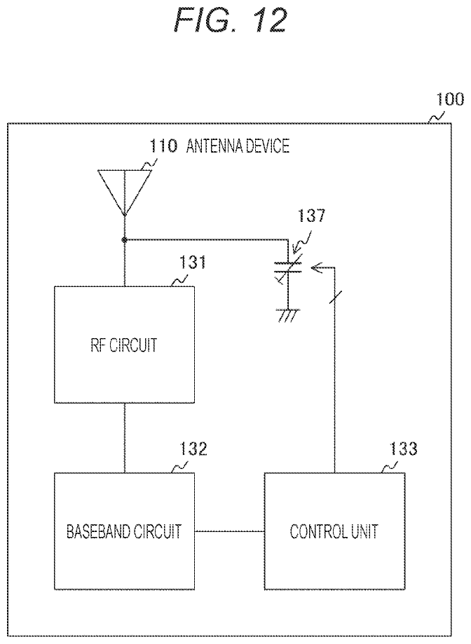

FIG. 12 is a block diagram showing a configuration example of the antenna device 100 according to the third embodiment of the present technology. The antenna device 100 is different from that of the second embodiment in that a variable reactance element 137 is arranged instead of the reactance element 120.

The variable reactance element 137 is, for example, a variable inductance element (varactor diode or the like). Further, the control unit 133 can dynamically control a reactance value of the variable reactance element 137 by using a control signal. This makes it possible to dynamically change the resonant frequency. Note that the variable reactance element 137 is an example of a reactance recited in the claims.

A control signal to the variable reactance element 137 is transmitted by an interface such as a mobile industry processor interface (MIPI). Alternatively, the control signal is transmitted by a serial peripheral interface (SPI), a general-purpose input/output (GPIO) interface, or an analog voltage.

As described above, according to the third embodiment of the present technology, the control unit 133 controls a reactance element value of the variable reactance element 137, and thus the resonant frequency can be dynamically changed.

### Modification Example

In the third embodiment described above, the reactance element value is controlled by the variable reactance element 137. However, a method of controlling the reactance value is not limited to this configuration. The antenna device 100 according to a modification example of the third embodiment is different from that of the third embodiment in that the reactance value is controlled by changing a connection configuration of a plurality of reactance elements.

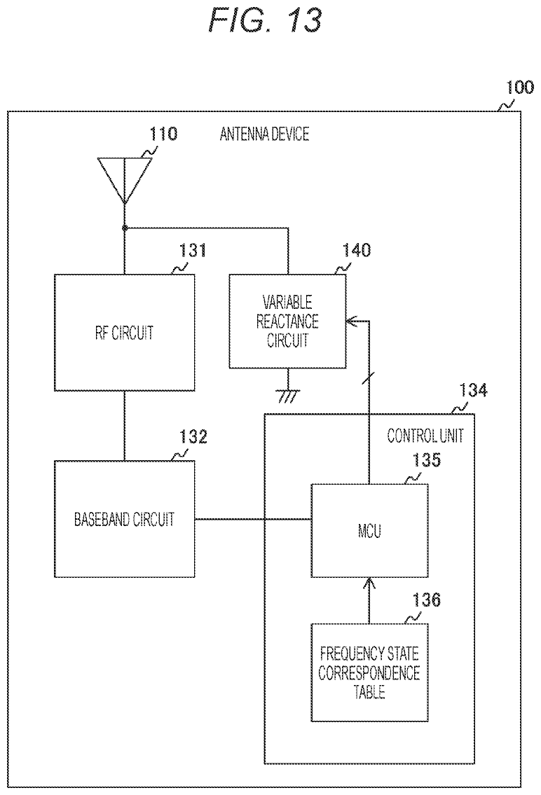

FIG. 13 is a block diagram showing a configuration example of the antenna device 100 according to the modification example of the third embodiment of the present technology. The antenna device 100 according to the modification example of the third embodiment is different from that of the third embodiment in that a variable reactance circuit 140 and a control unit 134 are provided instead of the variable reactance element 137 and the control unit 133. Further, the control unit 134 includes a micro control unit (MCU) 135 and a frequency state correspondence table 136. Note that the variable reactance circuit 140 is an example of the reactance recited in the claims.

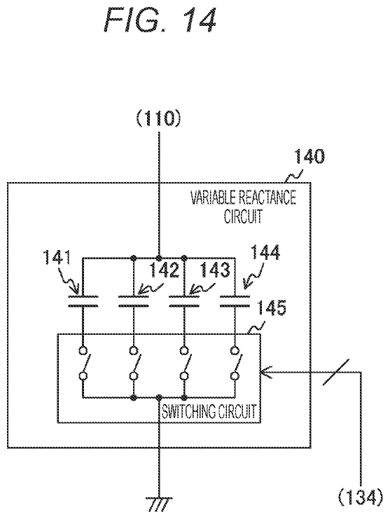

FIG. 14 is a circuit diagram showing a configuration example of the variable reactance circuit 140 according to the modification example of the third embodiment of the present technology. The variable reactance circuit 140 includes reactance elements 141 to 144 and a switching circuit 145.

The reactance elements 141 to 144 are connected in parallel between the horizontal antenna element 113 of the antenna 110 and the switching circuit 145. As illustrated in FIG. 14, for example, a capacitive element is used as the reactance elements 141 to 144. Reactance values thereof may be different from each other or may be the same. The switching circuit 145 connects the reactance elements 141 to 144 to a reference potential (i.e., the ground substrate 111) under the control of the control unit 134. The plurality of reactance elements 141 to 144 may be connected, or no reactance element may be connected.

Note that the variable reactance circuit 140 is connected in parallel to the antenna 110, and a method of connecting a variable element such as the variable reactance circuit 140 in parallel to the antenna as described above is called aperture tuning in some cases.

The frequency state correspondence table 136 is a table in which a connection state of the switching circuit 145 is associated with the resonant frequency at that time.

The MCU 135 controls the switching circuit 145 with reference to the frequency state correspondence table 136 and connects the reactance element corresponding to a target resonant frequency.

As described above, according to the modification example of the third embodiment of the present technology, the switching circuit 145 switches the reactance elements to be connected, and thus the resonant frequency can be dynamically changed.

### 4. Fourth Embodiment

In the first embodiment described above, only the antenna 110 is connected to the radio frequency signal source 139. In this configuration, however, the impedance matching and the adjustment of the resonant frequency in the antenna 110 may be difficult due to shortage of an inductor component and the like. The antenna device 100 according to a fourth embodiment is different from that of the first embodiment in that a variable reactance element is added.

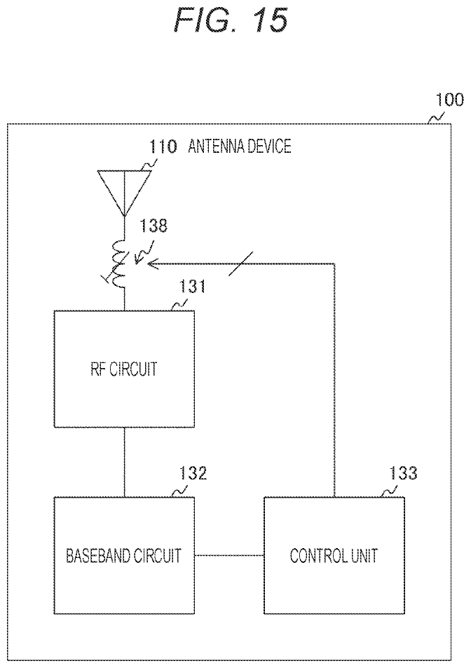

FIG. 15 is a block diagram showing a configuration example of the antenna device 100 according to the fourth embodiment of the present technology. The antenna device 100 according to the fourth embodiment is different from that of the first embodiment in that a variable reactance element 138 is further provided. As illustrated in FIG. 15, for example, a variable inductance element is used as the variable reactance element 138. The variable reactance element 138 is inserted between the antenna 110 and the RF circuit 131. In other words, the variable reactance element 138 is connected in series to antenna 110.

Further, the control unit 133 can dynamically control a reactance value of the variable reactance element 138 by using a control signal. This makes it possible to dynamically change the resonant frequency. Note that the variable reactance element 138 is an example of the reactance recited in the claims.

Note that the second and third embodiments are also applicable to the antenna device 100 of the fourth embodiment. Further, a reactance element having a fixed reactance value can also be connected, instead of the variable reactance element 138.

As described above, according to the fourth embodiment of the present technology, the control unit 133 controls the reactance value of the variable reactance element 138, and thus the resonant frequency can be dynamically changed.

### Modification Example

In the fourth embodiment described above, the reactance value is controlled by the variable reactance element 138. However, a method of controlling the reactance value is not limited to this configuration. The antenna device 100 according to a modification example of the fourth embodiment is different from that of the fourth embodiment in that the reactance value is controlled by changing a connection configuration of a plurality of reactance elements.

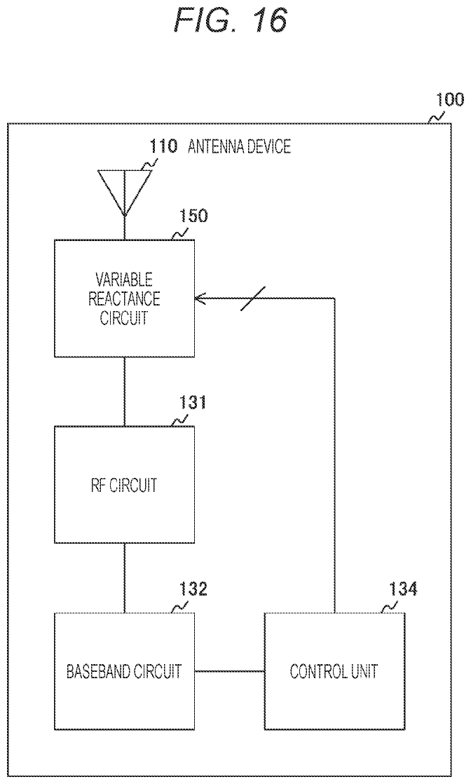

FIG. 16 is a block diagram showing a configuration example of the antenna device 100 according to the modification example of the fourth embodiment of the present technology. The antenna device 100 according to the modification example of the fourth embodiment is different from that of the fourth embodiment in that a variable reactance circuit 150 and the control unit 134 are provided instead of the variable reactance element 138 and the control unit 133. Note that the variable reactance circuit 150 is an example of the reactance recited in the claims.

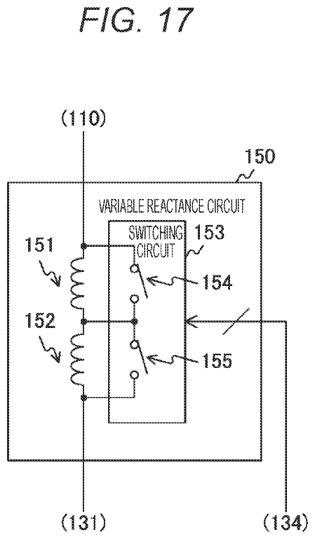

FIG. 17 is a circuit diagram showing a configuration example of the variable reactance circuit 150 according to the modification example of the fourth embodiment of the present technology. The variable reactance circuit 150 includes reactance elements 151 and 152 and a switching circuit 153. The switching circuit 153 includes switches 154 and 155.

The reactance elements 151 and 152 are connected in series between the antenna 110 and the RF circuit 131. As illustrated in FIG. 17, for example, an inductance element is used as the reactance elements 151 and 152. Reactance values thereof may be different from each other or may be the same. The switch 154 short-circuits both ends of the reactance element 151 under the control of the control unit 134. The switch 155 short-circuits both ends of the reactance element 152 under the control of the control unit 134.

The control unit 134 controls the switching circuit 153 to connect the variable reactance element corresponding to a target resonant frequency.

Note that the two reactance elements 151 and 152 are connected, but three or more reactance elements can also be connected. Three or more switches can also be arranged in accordance with the number of reactance elements to be connected.

As described above, according to the modification example of the fourth embodiment of the present technology, the switching circuit 153 switches the reactance elements to be connected, and thus the resonant frequency can be dynamically changed.

### 5. Fifth Embodiment

In the first embodiment described above, only one vertical antenna element is arranged, but the number of vertical antenna elements is not limited to one. The antenna device 100 according to a fifth embodiment is different from that of the first embodiment in that two vertical antenna elements are provided.

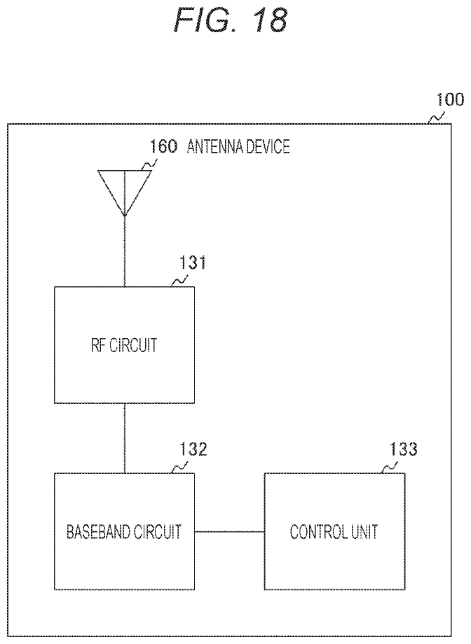

FIG. 18 is a block diagram showing a configuration example of the antenna device 100 according to the fifth embodiment of the present technology. The antenna device 100 according to the fifth embodiment is different from that of the first embodiment in that an antenna 160 is arranged instead of the antenna 110.

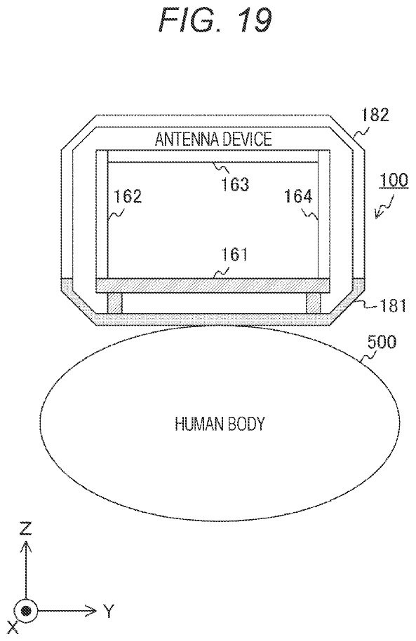

FIG. 19 illustrates an example of a cross-sectional view of the antenna device 100 according to the fifth embodiment of the present technology. The antenna 160 includes a ground substrate 161, vertical antenna elements 162 and 164, and a horizontal antenna element 163.

A connection configuration of the ground substrate 161, the vertical antenna element 162, and the horizontal antenna element 163 is similar to the connection configuration of the ground substrate 111, the vertical antenna element 112, and the horizontal antenna element 113 of the first embodiment, respectively.

The horizontal antenna element 163 has one end connected to one end of the vertical antenna element 162 and another end connected to one end of the vertical antenna element 164. In addition, another end of the vertical antenna element 162 is connected to the radio frequency signal source 139 via a feed point (not illustrated), and another end of the vertical antenna element 164 is connected to the ground substrate 161.

Note that the vertical antenna element 162 is an example of a first vertical antenna element recited in the claims, and the vertical antenna element 164 is an example of a second vertical antenna element recited in the claims.

Note that each of the second to fourth embodiments is also applicable to the antenna device 100 of the fifth embodiment.

### 6. Sixth Embodiment

In the fifth embodiment described above, only the antenna 160 is connected to the radio frequency signal source 139. In this configuration, however, the impedance matching and the adjustment of the resonant frequency in the antenna 160 may be difficult due to the shortage of the capacitive component and the like. The antenna device 100 according to a sixth embodiment is different from that of the fifth embodiment in that a reactance is added. Herein, the reactance may be either a capacitive reactance or an inductive reactance.

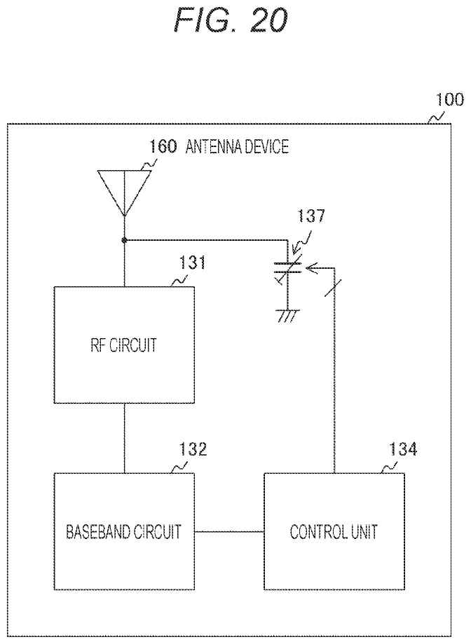

FIG. 20 is a block diagram showing a configuration example of the antenna device 100 according to the sixth embodiment of the present technology. The antenna device 100 according to the sixth embodiment is different from that of the first embodiment in that the variable reactance element 137 is further provided.

Note that the variable reactance circuit 140 illustrated in FIG. 14 can be provided, instead of the variable reactance element 137. Further, the reactance element 120 having a fixed value can also be connected, instead of the variable reactance element 137 or the variable reactance circuit 140.

As described above, according to the sixth embodiment of the present technology, the variable reactance element 137 is connected to the antenna 160, and thus the impedance matching and the adjustment of the resonant frequency can be performed by changing a capacity value thereof.

### 7. Seventh Embodiment

In the fifth embodiment described above, only the antenna 160 is connected to the radio frequency signal source 139. In this configuration, however, the impedance matching and the adjustment of the resonant frequency in the antenna 160 may be difficult due to shortage of an inductance component and the like. The antenna device 100 according to a seventh embodiment is different from that of the fifth embodiment in that a reactance is added. Herein, the reactance may be either a capacitive reactance or an inductive reactance.

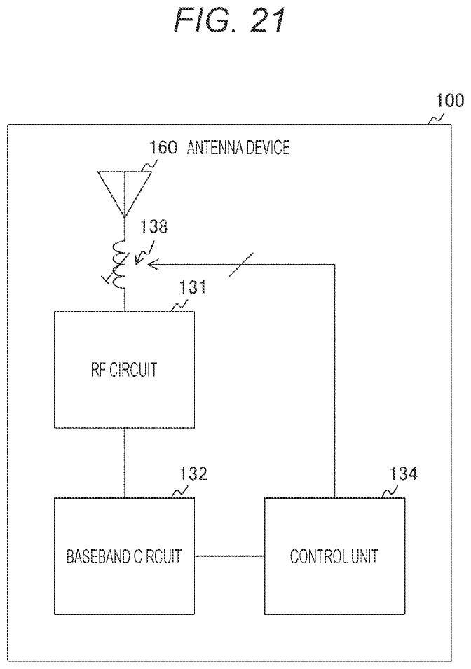

FIG. 21 is a block diagram showing a configuration example of the antenna device 100 according to the seventh embodiment of the present technology. The antenna device 100 according to the seventh embodiment is different from that of the fifth embodiment in that the variable reactance element 138 is further provided.

Note that the variable reactance circuit 150 illustrated in FIG. 17 can be provided, instead of the variable reactance element 138. Further, a reactance having a fixed reactance value can also be connected, instead of the variable reactance element 138 or the variable reactance circuit 150.

As described above, according to the seventh embodiment of the present technology, the variable reactance element 138 is connected to the antenna 160, and thus the impedance matching and the adjustment of the resonant frequency can be performed by changing the reactance value.

### 8. Eighth Embodiment

In the first embodiment described above, the ground substrate 111 having a uniform thickness is arranged in the antenna device 100. In this configuration, however, the ground substrate may not be sufficiently close to the human body depending on a structure of the device. Therefore, the effect caused by the image current may not be sufficiently obtained. The antenna device 100 according to an eighth embodiment is different from that of the first embodiment in that a gain is improved by changing a thickness of a part of the ground substrate 111 so that the ground substrate is sufficiently close to the human body.

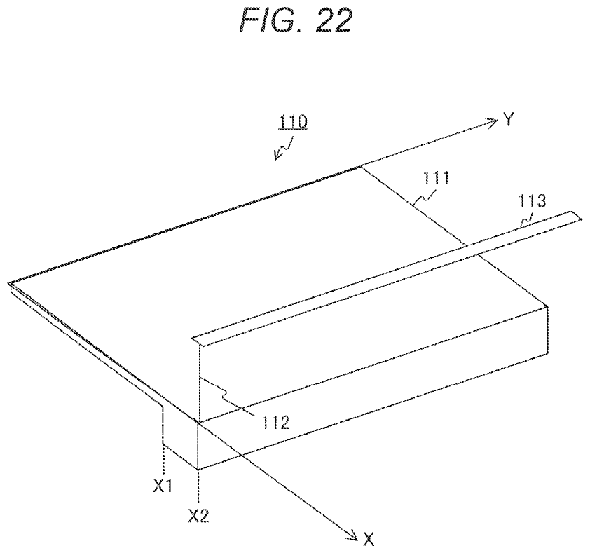

FIG. 22 illustrates an example of a perspective view of the antenna 110 according to the eighth embodiment of the present technology. The antenna 110 according to the eighth embodiment is different from that of the first embodiment in that the thickness of the ground substrate 111 is ununiform.

In the X direction, a representative point of the vertical antenna element 112 (e.g., a left end as seen from the Y direction) is located on a coordinate X2 at a left end of the ground substrate 111. In the X direction, the thickness of the ground substrate 111 within a predetermined range from a predetermined coordinate X1 to the predetermined coordinate X2 is larger than that within a range other than the predetermined range.

In the ground substrate 111, a current density near a part immediately below the vertical antenna element 112 is higher than that in a part far from the vertical antenna element 112. Therefore, the thickness from the coordinates X1 to X2 immediately below the vertical antenna element 112 is increased to bring the ground substrate close to the human body, which makes it possible to easily generate the image current. Therefore, the gain of the antenna 110 can be improved.

The gain of the antenna 110 can also be improved by uniformly thickening the entire ground substrate 111 to bring the ground substrate close to the human body. In this case, however, a weight of the antenna device 100 may increase, and a peripheral circuit or member may interfere with the ground substrate 111. Therefore, in a case where it is difficult to uniformly thicken the entire ground substrate 111, it is preferable to partially thicken the ground substrate 111 to improve the gain of the antenna 110.

Note that each of the second to seventh embodiments is also applicable to the antenna device 100 of the eighth embodiment.

As described above, according to the eighth embodiment of the present technology, because the ground substrate 111 is partially thickened, the ground substrate is accordingly brought close to the human body. This increases the image current, which makes it possible to improve the gain of the antenna 110.

Note that the above embodiments show examples for embodying the present technology, and the matters in the embodiments and the matters specifying the invention in the claims have a corresponding relationship. Similarly, the matters specifying the invention in the claims and the matters in the embodiments of the present technology represented by the same names as those in the matters specifying the invention in the claims have a corresponding relationship. However, the present technology is not limited to the embodiments, and can be embodied by applying various modification examples to the embodiments within the gist thereof.

Note that the effects described in this specification are merely examples and are not limited, and other effects may be exerted.

Note that the present technology may also have the following configurations.

(1) An antenna device including:

a ground substrate connected to a ground terminal of a radio frequency signal source;

a vertical antenna element having one end connected to a feed point of the radio frequency signal source and extending in a direction vertical to a substrate surface of the ground substrate; and

a horizontal antenna element connected to another end of the vertical antenna element and extending in a horizontal direction parallel to the substrate surface.

(2) The antenna device according to (1), further including

a housing including a conductive member having a surface parallel to the ground substrate, in which

the ground substrate is connected to the conductive member.

(3) The antenna device according to (1) or (2), further including

a reactance connected to the one end of the vertical antenna element.

(4) The antenna device according to (3), further including

a control unit that controls a reactance value of the reactance.

(5) The antenna device according to any one of (1) to (4), further including

a reactance element connected in series to the one end of the vertical antenna element.

(6) The antenna device according to (5), further including

a control unit that controls a reactance value of the reactance element.

(7) The antenna device according to any one of (1) to (6), in which:

the vertical antenna element includes first and second vertical antenna elements;

one end of the horizontal antenna element is connected to the another end of the first vertical antenna element; and

another end of the horizontal antenna element is connected to one end of the second vertical antenna element.

(8) The antenna device according to any one of (1) to (7), in which:

the vertical antenna element is connected to a predetermined position of the ground substrate in a predetermined direction vertical to the vertical direction and the horizontal direction; and

in the predetermined direction, a thickness of the ground substrate within a predetermined range including the predetermined position is larger than a thickness of the ground substrate within a range other than the predetermined range.

(9) The antenna device according to any one of (1) to (8), in which:

the vertical antenna element includes first and second vertical antenna elements;

the horizontal antenna element includes first and second horizontal antenna elements having different lengths;

one end of the first vertical antenna element is connected to one end of the first horizontal antenna element; and

one end of the second vertical antenna element is connected to one end of the second horizontal antenna element.

### REFERENCE SIGNS LIST

100 Antenna device
110, 160 Antenna
111, 161 Ground substrate
112, 115, 162, 164 Vertical antenna element
113, 116, 163 Horizontal antenna element
120 Reactance element
121 to 124, 141 to 144 Reactance element
131 RF circuit
132 Baseband circuit
133, 134 Control unit
135 MCU
136 Frequency state correspondence table
137 Variable reactance element
138 Variable reactance element
139 Radio frequency signal source
140 Variable reactance circuit
146 to 149 Resistor
145, 153 Switching circuit
150 Variable reactance circuit
151, 152 Reactance element
154, 155 Switch
181 Metal-plated member
182 Plastic member
191 Display surface
192 Wristwatch band

1. An antenna device comprising:
a ground substrate connected to a ground terminal of a radio frequency signal source;
a vertical antenna element having one end connected to a feed point of the radio frequency signal source and extending in a direction vertical to a substrate surface of the ground substrate; and
a horizontal antenna element connected to another end of the vertical antenna element and extending in a horizontal direction parallel to the substrate surface.

2. The antenna device according to claim 1, further comprising
a housing including a conductive member having a surface parallel to the ground substrate, wherein
the ground substrate is connected to the conductive member.

3. The antenna device according to claim 1, further comprising
a reactance connected to the one end of the vertical antenna element.

4. The antenna device according to claim 3, further comprising
a control unit that controls a reactance value of the reactance.

5. The antenna device according to claim 1, further comprising
a reactance element connected in series to the one end of the vertical antenna element.

6. The antenna device according to claim 5, further comprising
a control unit that controls a reactance value of the reactance element.

7. The antenna device according to claim 1, wherein:
the vertical antenna element includes first and second vertical antenna elements;
one end of the horizontal antenna element is connected to the another end of the first vertical antenna element; and
another end of the horizontal antenna element is connected to one end of the second vertical antenna element.

8. The antenna device according to claim 1, wherein:
the vertical antenna element is connected to a predetermined position of the ground substrate in a predetermined direction vertical to the vertical direction and the horizontal direction; and
in the predetermined direction, a thickness of the ground substrate within a predetermined range including the predetermined position is larger than a thickness of the ground substrate within a range other than the predetermined range.

9. The antenna device according to claim 1, wherein:
the vertical antenna element includes first and second vertical antenna elements;
the horizontal antenna element includes first and second horizontal antenna elements having different lengths;
one end of the first vertical antenna element is connected to one end of the first horizontal antenna element; and
one end of the second vertical antenna element is connected to one end of the second horizontal antenna element.
